(19) United States
(12) Patent Application Publication
(10) Pub. No.: US 2007/0086769 A1
(43) Pub. Date: Apr. 19, 2007

(54) Image taking apparatus

(75) Inventors: Kenji Watanabe, Tokyo (JP); Hiroshi Kibayashi, Niiza-shi (JP); Katsumi Ohtsuka, Tokyo (JP); Chie Nemoto, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 11/543,366

(22) Filed: Oct. 5, 2006

(30) Foreign Application Priority Data
Oct. 14, 2005 (JP) JP2005-300972
Oct. 14, 2005 (JP) JP2005-300973
Oct. 31, 2005 (JP) JP2005-316344
Oct. 31, 2005 (JP) JP2005-316346
Oct. 31, 2005 (JP) JP2005-316349

(51) Int. Cl. G03B 3/10

(52) U.S. Cl. 396/133

(57) ABSTRACT

An image taking apparatus comprising a frame, an image taking lens that includes at least one movable lens that can be moved in a direction of the optical axis of the image taking lens with respect to said frame, a lens frame that supports the movable lens, an actuator for moving the movable lens; and a movable frame that is coupled to a movable element of said actuator, wherein the lens frame and the movable frame are formed integrally.

The present application is based on Japanese Patent Application No. 2005-300972 filed on Oct. 14, 2005, Japanese Patent Application No. 2005-300973 filed on Oct. 14, 2005, Japanese Patent Application No. 2005-316344 filed on Oct. 31, 2005, Japanese Patent Application No. 2005-316346 filed on Oct. 31, 2005 and Japanese Patent Application No. 2005-316349 filed on Oct. 31, 2005, the contents of which are incorporated herein by reference.

### BACKGROUND OF THE INVENTION

1. Field of the Invention

The present invention relates to image taking apparatuses, for example, image taking (imaging) apparatuses that are ideally suitable for use in image taking apparatuses employing a solid-state image sensor such as, for example, a CCD type image sensor or a CMOS type image sensor.

2. Description of the Related Art

In recent years, because of great improvement in the performances of image taking apparatuses employing a solid-state image sensor such as a CCD (Charge Coupled Device) type image sensor or a CMOS (Complementary Metal Oxide Semiconductor) type image sensor, mobile telephones equipped with image taking apparatuses having the auto-focus function (hereinafter referred to as the AF function) are proliferating widely.

Lens driving apparatuses which can drive the lens in the direction of the optical axis and in which an actuator is placed on the periphery of the lens have been disclosed in Patent Document 1 and Patent Document 2 as conventional examples in which it is possible to use them in such image taking apparatuses.

Patent Document 1: JP-A No. 2004-280031. (Hereinafter, JP-A refers to Japanese Patent Publication Open to Public Inspection)

Patent Document 2: JP-A No. 2004-347890

The lens driving apparatus described in Patent Document 1, the gear that couples the coil which is the movable element of the actuator and the lens holder that holds the lens are separate bodies. By using this type of structure, it is possible to have relative displacement in the direction of the optical axis of the carrier and the lens holder at the time of assembling, thereby making it possible to adjust the focus point position. However, when the carrier and the lens holder are separate bodies, the number of components increases and it is likely that the assembling operation becomes tedious. In addition, since the carrier and the lens holder are overlapping each other in a direction perpendicular to the optical axis, the total thickness becomes large and it is likely that the structure of the apparatus has a greater diameter by that extent.

Further, in an image taking apparatus provided with a plurality of lenses, when carrying out focusing by moving one lens in the direction of the optical axis, the optical performance is likely to get deteriorated if any tilt or shift of the optical axis occurs due to the movement of the lens. This problem occurs easily in the case of moving the lens using a voice coil motor as the actuator. In contrast with this, there is an attempt to move a plurality of lenses in the direction of the optical axis during focusing, and since any tilt or shift of the optical axis is suppressed because of this, it is possible to obtain a high optical performance. However, in order to move a plurality of lenses it becomes necessary to increase the driving force of the actuator.

For example, in the case of a voice coil motor, it is possible to increase the driving force by increasing the number of turns of the coil wire, by increasing the coil length, by increasing the current, or by increasing the magnetic flux density. However, since in general the magnetic flux density is decided depending on the characteristics of the magnet, it is difficult to greatly enhance that magnetic flux density. Further, if the current is increased, the heat generation also increases, and, in the case of the drive target being a plastic lens, this is likely to invite reduction in the optical performance. In contrast with this, although increasing the number of turns of the coil are increasing the length of the coil are possible relatively easily, this will cause the actuator to become larger in size.

However, in the image taking apparatus disclosed in Patent Document 2, since the external diameters of the lenses in the lens group constituting the imaging lens are almost equal, and since the actuator for driving the lenses is placed on the outer side in a direction perpendicular to the optical axis, it has a large dimension in the direction of the diameter. In order to drive, for example, four lenses using this structure, it becomes necessary to increase further the number of turns of the coil and to increase the coil length, and it becomes difficult to install this in a mobile telephone etc., because of the increase in the dimension in the direction of the diameter. On the other hand, if the effective diameter of the lens is made small, although it is possible to make the actuator larger by that amount, it is difficult to obtain the necessary optical characteristics.

The present invention was made in view of the problems in these conventional technologies, and the purpose of the present invention is to provide an image taking apparatus that has a compact structure and that can be manufactured at a low cost by suppressing the number of components.

### SUMMARY OF THE INVENTION

A preferred embodiment of the present invention is an image taking apparatus having a frame, an image taking lens that includes at least one movable lens that can be moved in the direction of the optical axis with respect to said frame, a lens frame that supports said movable lens, an actuator for moving said movable lens, and a movable frame that is coupled to the movable element of said actuator, with the feature that said lens frame and said movable frame are formed integrally.

### BRIEF DESCRIPTION OF THE DRAWINGS

FIG. 1 is a perspective view diagram of an image taking apparatus 50 according to the first preferred embodiment.

FIG. 2 is a diagram as seen in the direction of the arrow after cutting the image taking apparatus 50 of FIG. 1 in a plane containing the line I-I.

FIG. 3 is a drawing showing the state in which the image taking apparatus 50 has been installed in a mobile telephone unit 100 used as a portable terminal.

FIG. 4 is a control block diagram of the portable mobile telephone unit 100.

FIG. 5 is a perspective view diagram of an image taking apparatus 50 according to the second preferred embodiment.

FIG. 6 is a diagram as seen in the direction of the arrow after cutting the image taking apparatus 50 of FIG. 5 in a plane containing the line II-II.

FIG. 7(a) is a diagram of the fourth lens L4 as viewed from the object side, and FIG. 7(b) is a diagram as seen in the direction of the arrow after cutting the fourth lens L4 of FIG. 7(a) in a plane containing the line IIIB-IIIB.

FIG. 8(a) is a diagram of the third lens L3 as viewed from the image side, and FIG. 8(b) is a diagram as seen in the direction of the arrow after cutting the third lens L3 of FIG. 8(a) in a plane containing the line IVB-IVB.

FIG. 9 is a diagram as seen in the direction of the arrow after cutting the image taking apparatus 50 of FIG. 1 according to the third preferred embodiment in a plane containing the line I-I.

FIG. 10 is a diagram as seen in the direction of the arrow after cutting the image taking apparatus 50 of FIG. 1 according to the fourth preferred embodiment in a plane containing the line I-I.

FIG. 11 is a cross-sectional view diagram of a moving tube and a movable lens according to a modified example of the fourth preferred embodiment.

FIG. 12 is a perspective view diagram of an image taking apparatus 50 according to the fifth preferred embodiment.

FIG. 13 is a diagram as seen in the direction of the arrow after cutting the image taking apparatus 50 of FIG. 12 in a plane containing the line I-I.

FIG. 14 is a drawing showing the state in which the image taking apparatus 50 has been installed in a mobile telephone unit 100 used as a portable terminal.

FIG. 15(a) is a diagram for explaining the effective diameter of the image taking lens.

FIG. 15(b) is a diagram for explaining the values of the condition equations (1) and (2).

### DETAILED DESCRIPTION OF THE INVENTION

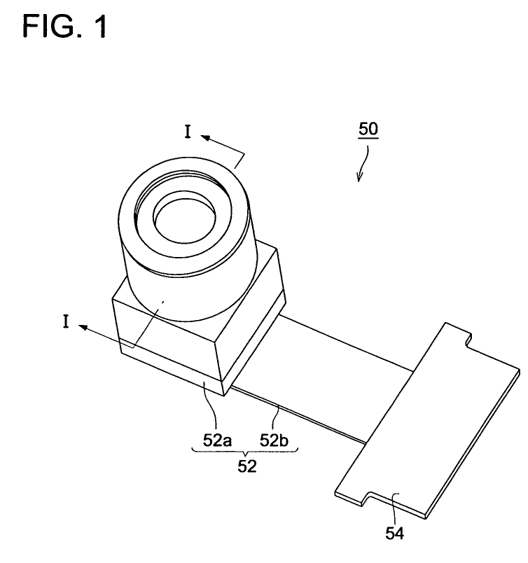

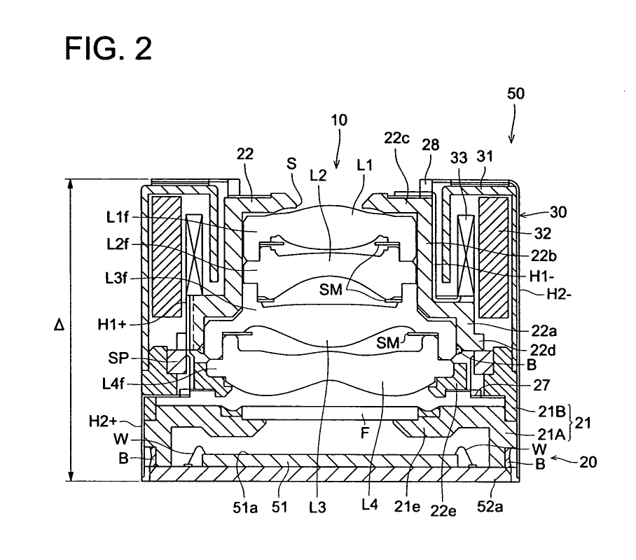

In the following, some preferred embodiments of the present invention are described in detail with reference to the drawings. FIG. 1 is a perspective view diagram of an image taking apparatus 50 according to the first preferred embodiment, and FIG. 2 is a diagram as seen in the direction of the arrow after cutting the image taking apparatus 50 of FIG. 1 in a plane containing the line I-I.

The above image taking apparatus 50 is provided with a CMOS type image sensor 51 as a solid-state image sensor having a photoelectric conversion section 51a, an image taking lens 10 as an imaging lens that causes the photoelectric conversion section 51a of this image sensor 51 to photograph the subject image, an IR cutoff filter F placed between the image sensor 51 and the image taking lens 10, a substrate 52 that not only supports the image sensor 51 but also has the terminals 54 for external connections (FIG. 1) that carries out the transmission and reception of its electrical signals, an assembly frame 20 that supports the image taking lens 10, and an actuator 30 (also called a focusing actuator) that drives the focusing lens, and all of these are formed in an integral manner. Further, the height C in the direction of the optical axis of this image taking apparatus 50 is 10 mm or less.

The above image sensor 51 has formed at the center of the flat surface on its light receiving side a photoelectric conversion section 51a as the light receiving section in which the pixels (photoelectric conversion devices) are arranged in a two-dimensional array, and signal processing circuits (not shown in the figure) are formed in the region surrounding it. These signal processing circuits are formed to have a drive circuit section that successively drives each of the pixels and obtains the signal charge, an A/D conversion section that converts each signal charge into a digital signal, and a signal processing section that forms the image output signal using these digital signals. In addition, in the neighborhood of the outer edge of the flat surface on the light receiving side of the image sensor 51, a plurality of pads (not shown in the figure) are placed and are connected to the substrate 52 through wires. The image sensor 51 converts the signal charge from the photoelectric conversion section 51a into image signals such as digital YUV signals, etc., and outputs them to the specific circuits on the substrate 52 via the wires W. Here, Y is the luminance signal, U (=R−Y) is the difference signal between the red signal and the luminance signal, and V (=B−Y) is the difference signal between the blue signal and the luminance signal. Further, the image sensor need not be limited to the above CMOS type image sensor, but it is also possible to use other devices such as a CCD image sensor, etc.

On one of the flat surfaces of the substrate 52 is provided a supporting flat plate 52a that supports the above image sensor 51 and the outer tube 21, and a flexible circuit board 52b (FIG. 1) is provided whose one end part is connected to the supporting flat plate 52a.

The supporting flat plate 52a has provided on its surface a plurality of pads for signal transmission, which pads are connected to the wires W from the image sensor 51 described above and are also connected to the flexible circuit board 52b.

The flexible circuit board 52b, which has one of its end parts connected to the supporting flat plate 52a as described above, connects the supporting flat plate 52a and the external circuits (for example, the control circuits of a higher level apparatus in which the image taking apparatus is installed) via the terminals 54 for external connections provided on its other end part, receives from the external circuits the supply of power supply voltage or clock signals for driving the image sensor 51, and also makes it possible to output the digital YUV signals to the external circuits. In addition, the middle part along the longitudinal direction of the flexible printed circuit board 52b has flexibility or easy deformability, and because of its deformation, freedom has been provided in the orientation or placement of the external output terminals with respect to the supporting flat plate 52a.

The assembly frame 20 made of a light shielding member includes an outer tube 21 which is composed of a lower tube 21A which is placed so as to encircle the image sensor 51 and whose bottom end is adhered to the substrate 52 using an adhesive B, and an upper tube 21B with a short cylindrical shape which is mounted on the top part of the bottom tube 21A.

In FIG. 2, an IR cutoff filter F is mounted on the flange part 21a that extends from the internal circumference of the lower tube 21A in a direction perpendicular to the optical axis.

The moving tube 22, placed so as to be movable relative to the assembly frame 20, is constructed to have a large tubular part 22a, a small tubular part 22b coupled to its top end part, a small flange part 22c formed on its top end part, and a large flange part 22d that extends in the radial direction from the bottom end part of the large tubular part 22a, and furthermore, a supporting member 22e has been provided that is installed so as to cover the large tubular part 22a. The moving tube 22 internally retains the first lens L1, the second lens L2, and the third lens L3, in that order from the object side. A stopper SP has been provided on the inner circumference of the upper tube 21B, and restricts the movement of the moving tube 22 by coming into contact with the large flange part 22d. The central opening in the small flange part 22c becomes the aperture opening S. The moving tube 22 constitutes the lens frame and the moving frame mentioned in the claims.

The flange section L1f of the first lens L1 butts against and engages with the top part of the flange section L2f of the second lens L2 so as to enclose it. Further, the flange section L3f of the third lens L3 butts against and engages with the bottom part of the flange section L2f of the second lens L2 so as to enclose it. The external diameters of the first lens L1 and the second lens L2 are slightly smaller than the external diameters of the third lens L3. Therefore, in a condition described later, when the lenses L1 to L3 are assembled inside the small tubular part 22b, the optical axis of the lens relative to the moving tube 22 is positioned with a high accuracy due to the mating between the internal circumferential surface of the small tubular part 22b and the external diameter of the third lens L3, and also because of the mating between the flange parts, the optical axis of the third lens L3 and the optical axes of the first lens L1 and the second lens L2 are positioned with a high accuracy.

On the other hand, since the flange part L4f of the fourth lens L4 which is the lens on the imaging side butts against and engages with the flange part L3f of the third lens L3, the positioning can be done accurately of the optical axis of the fourth lens L4 with respect to the moving tube 22. The supporting member 22e has been affixed to the bottom surface of the flange part L4f of the fourth lens L4.

A tubular shaped actuator 30 has been placed on the outside in a direction perpendicular to the optical axis of the small tubular part 22b of the moving tube 22. The actuator 30 is constructed to have a tubular shaped coil 33 that is adhered (or insert-formed) to the top end of the large tubular part 22a of the moving tube 22 and that has turns wound in the circumferential direction centering on the optical axis and extending in the direction of the optical axis, a cylindrical magnet 32 placed above the upper tube 21B so as to enclose the coil 33, and a cylindrical yoke 31 with its bottom end attached to the upper tube 21B so that it not only supports the magnet 32 but also covers the coil 33 from above up to its inner circumference. Further, it is also possible to mount the magnet 32 to the moving tube 22 and to attach the coil 33 to the upper tube 21B.

A spring member 27, obtained by coupling donut-shaped circular plates with different diameters while shifting the phase of the coupling position, has its outer circumferential part fixed in the neighborhood of the bottom end of the upper tube 21B, and its inner circumferential part is fixed to the bottom surface of the supporting member 22e. On the other hand, the spring member 28 having a shape similar to the spring member 27 has its outer circumferential side fixed on the top surface of the yoke 31, and its inner circumferential side is fixed to the top end of the moving tube 22. The spring members 27 and 28 generate the biasing force according to the movement of the moving tube 22 in the direction of the optical axis.

The positive terminal of the coil 33 of the actuator 30 is connected to the spring member 27 via the wiring H1+ that passes through the large flange part 22d of the moving tube 22 and goes around the outer wall of the supporting member 22e. In addition, the spring member 27 is connected to the substrate 52 via the wiring H2+ that passes through the outer wall of the upper tube 21B and goes around the outer wall of the lower tube 21A. Further, the negative terminal of the coil 33 is connected to the spring member 28 via the wiring H1− that passes around the outer wall of the small tubular part 22b. The spring member 28 is connected to the substrate 52 via the wiring H2− that passes around the yoke 31, the upper tube 21B and the lower tube 21A. Although the principle of operation of driving a voice coil motor is omitted here because it is very widely known, because of the magnetic force generated due to electrical power supplied to the coil 33 from the outside via the spring members 27 and 28 and the wirings H1+, H2+, H1−, and H2−, the coil 33 can be displaced with respect to the magnet 32 according to the supplied electrical power.

The image taking lens 10 has, in order from the object side, an aperture opening S, a first lens L1 having a positive refractive index and a projecting surface on the object side, a second lens L2 having a negative refractive index, a third lens L3 having a positive refractive index, and a fourth lens L4 having a negative refractive index. In the present preferred embodiment, although the lenses L1, L2, L3, and L4 constitute a focusing lens (also called a movable lens), since the external diameters of the lenses L1 to L3 have been made small compared to that of the lens L4, using this difference between the external diameters it has been made possible to install a large-sized actuator 30.

This image taking lens 10 carries out image formation of the photographed subject on the solid-state image sensor, while the aperture opening S and each of the lenses L1, L2, L3, and L4 all together constitute the optical system. The aperture opening S is a member that determines the F number of the overall imaging lens system.

The IR cutoff filter F held by the flange part 21a of the outer tube 21 in between the image taking lens 10 and the image sensor 51 is, for example, a member formed to have a rough rectangular shape or a circular shape.

In addition, light shielding masks SM are placed between the first lens L1 and the second lens L2, between the second lens L2 and the third lens L3, and between the third lens L3 and the fourth lens L4, and because of these, it is possible to prevent unwanted light outside the effective diameters of the lenses from entering near the solid-state image sensor, and to suppress the generation of ghosts or flare.

The assembly and adjustment aspects of the present preferred embodiment are described here. The image sensor 51 is mounted on the supporting flat plate 52a, the lower tube 21A to which the IR cutoff filter F has been attached is affixed on top of the supporting flat plate 52a, and further, the upper tube 21B is fixed. In this condition, the lenses L1 to L4 mated with each other while holding the supporting member 22e using a prescribed jig (not shown in the figure) are placed above the IR cutoff filter F. Thereafter, the spacing between the image sensor 51 and the set of lenses L1 to L4 is adjusted so as to get the optimum focusing position by making an inspection light beam enter via the lenses L1 to L4 and measuring the signal from the image sensor 51. While maintaining this spacing, the moving tube 22 is mated with the lenses L1 to L3 and fixed using an adhesive material B. Thereafter, the image taking apparatus 50 is completed assembling the actuator 30.

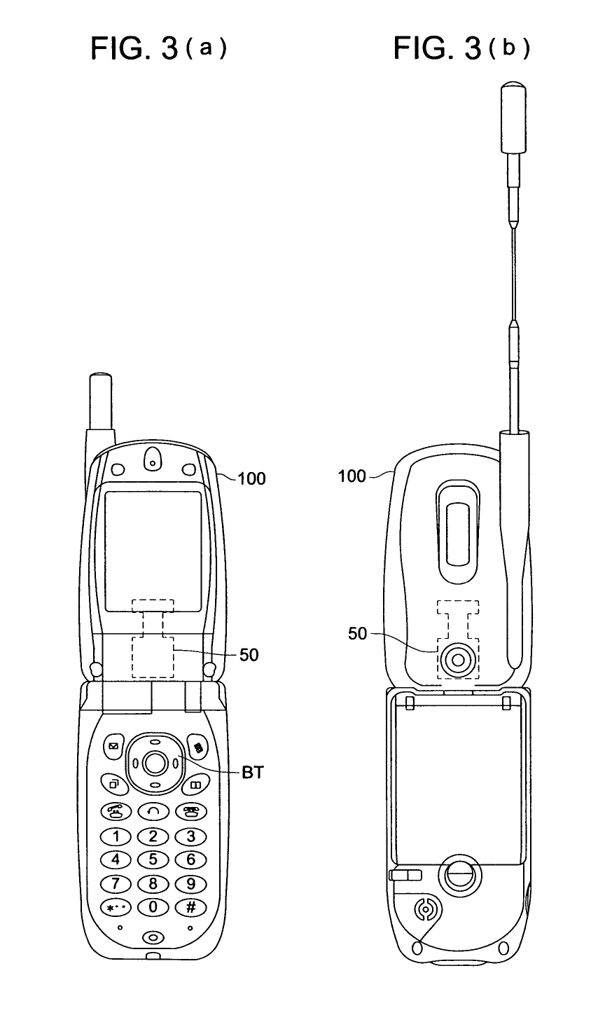

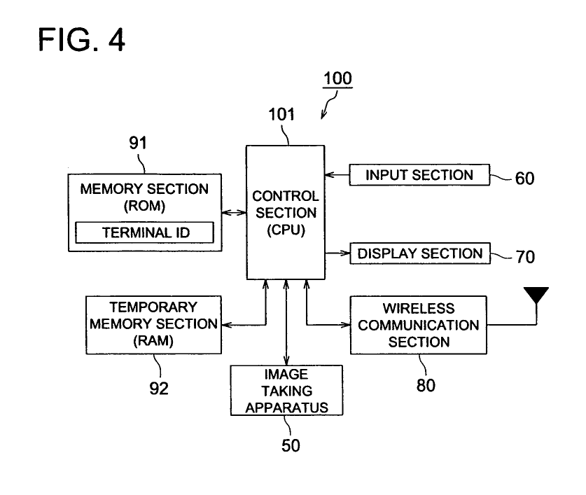

Next, the mode of using the above image taking apparatus 50 is described here. FIG. 3 is a drawing showing the state in which the image taking apparatus 50 has been installed in a mobile telephone unit 100 used as a portable terminal. Further, FIG. 4 is a control block diagram of the portable mobile telephone unit 100.

The image taking apparatus 50 is installed, for example, so that the object side end surface of the outer tube 21 in the image taking lens is provided on the back face of the mobile telephone unit 100 (the LCD display is taken as the front face) and is arranged so that it is at a position corresponding to below the LCD display section.

The terminals 54 for external connection of the image taking apparatus 50 are connected with the control section 101 of the mobile telephone unit 100, and output the image signals such as the luminance signal or the color difference signals to the control section 101.

On the other hand, the mobile telephone unit 100, as is shown in FIG. 4, is provided with a control section (CPU) 101 that not only controls comprehensively each of the sections but also executes programs according to the different operations, an input section 60 for entering instructions such as numbers, etc., a display section 70 that displays, apart from the prescribed data, the photographed images or videos, etc., a wireless communication section 80 for realizing various types of information communication with an external server, a storage section (ROM) 91 that stores the system programs of the mobile telephone unit 100, various types of processing programs, and various types of data such as the terminal ID, etc., a temporary storage section (RAM) 92 that is used as a working storage area that temporarily stores various types of processing programs or data executed by the control section 101, or the process data, or the image data photographed by the image taking apparatus 50, etc.

When the photographer holding the mobile telephone unit 100 points the optical axis of the image taking lens 10 of the image taking apparatus 50 towards the subject to be photographed, although the image signal is taken in to the image sensor 51, it is possible to detect out of focus condition by, for example, carrying out image plane AF processing, etc. Since the control section 101 supplies electrical power to the actuator 30 so that the lenses L1 to L4 are driven in a direction for eliminating this out of focus condition, electrical power is supplied to the coil 33 from the terminals 54 for external connections via the wirings H1+, H2+, H1−, and H2−. By matching the magnetic force generated due to this and the biasing force of the deformed spring members 27 and 28, since it is possible to move and hold the lenses L1 to L4 along with the moving tube 22 to the optimum focus matching position, it is possible to realize an appropriate auto-focus operation. Further, if the driving force of the actuator 30 is lost due to interruption of the supply of electrical power, the moving tube 22 returns to its original position.

At any desired instant of photographing, when the photographer presses the shutter release button BT shown in FIG. 3, the image signals are read into the image taking apparatus 50. The image signals input from the image taking apparatus 50 are transmitted to the control system of the above mentioned mobile phone unit 100, and is either stored in the storage section 92, or is displayed in the display section 70, and in addition, transmitted to outside as an image information via the wireless communication section 80.

According to the first preferred embodiment of the present invention, because not only the lenses L1 to L4 are retained by the integrally formed moving tube 22, but also because the coil 33 is directly adhered to the moving tube 22, since it is possible to make thin the thicknesses of the lenses L1 to L4, it is possible to suppress the external diameter of the image taking apparatus 50 by a corresponding amount, or since it is possible to acquire a larger installation space of the actuator 30, and since it is possible to increase the driving force by increasing the number of turns in the coil, it is possible to drive the four lenses L1 to L4 appropriately. In addition, it is possible to suppress the number of components and to reduce the tediousness of assembling.

According to the first preferred embodiment of the present invention, because the lens frame and the moving frame are formed integrally with the moving tube 22, since it is possible to make thin their wall thicknesses, and since it is possible to suppress the external diameter of the image taking apparatus to a small value, or since it is possible to acquire a larger installation space of the actuator, it is possible to drive appropriately by increasing the driving force by increasing the number of turns in the coil, even when a plurality of lenses are used as the movable lens. In addition, it is possible to suppress the number of components and to reduce the tediousness of assembling. Further, the words “formed integrally” here means that a single member is formed by injection molding of plastic material, molding formation of metallic material, or machining, etc., and does not include the case of bonding the parts by an adhesive, etc.

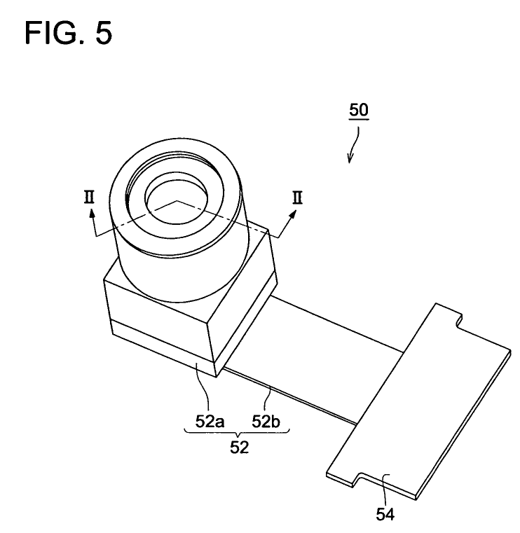

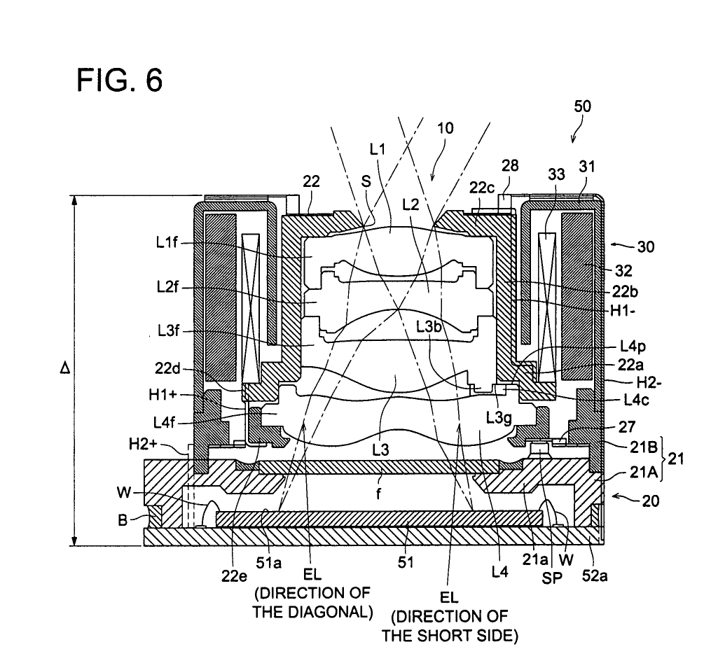

Next, a second preferred embodiment of the present invention is described here with reference to the drawings. FIG. 5 is a perspective view diagram of an image taking apparatus 50 according to the second preferred embodiment, and FIG. 6 is a diagram as seen in the direction of the arrow after cutting the image taking apparatus 50 of FIG. 5 in a plane containing the line II-II.

The above image taking apparatus 50 is provided with a CMOS type image sensor 51 as a solid-state image sensor having a photoelectric conversion section 51a, an image taking lens 10 as an imaging lens that causes the photoelectric conversion section 51a of this image sensor 51 to photograph the subject image, an IR cutoff filter F placed between the image sensor 51 and the image taking lens 10, a substrate 52 that not only supports the image sensor 51 but also has the terminals 54 for external connections (FIG. 5) that carries out the transmission and reception of its electrical signals, an assembly frame 20 that supports the image taking lens 10, and an actuator 30 (also called a focusing actuator) that drives the focusing lens, and all of these are formed in an integral manner. Further, the height C in the direction of the optical axis of this image taking apparatus 50 is 10 mm or less.

The above image sensor 51 has formed at the center of the flat surface on its light receiving side a photoelectric conversion section 51a as the light receiving section in which the pixels (photoelectric conversion devices) are arranged in a two-dimensional array, and signal processing circuits (not shown in the figure) are formed in the region surrounding it. These signal processing circuits are formed to have a drive circuit section that successively drives each of the pixels and obtains the signal charge, an A/D conversion section that converts each signal charge into a digital signal, and a signal processing section that forms the image output signal using these digital signals. In addition, in the neighborhood of the outer edge of the flat surface on the light receiving side of the image sensor 51, a plurality of pads (not shown in the figure) are placed and are connected to the substrate 52 through wires. The image sensor 51 converts the signal charge from the photoelectric conversion section 51a into image signals such as digital YUV signals, etc., and outputs them to the specific circuits on the substrate 52 via the wires W. Here, Y is the luminance signal, U (=R−Y) is the difference signal between the red signal and the luminance signal, and V (=B−Y) is the difference signal between the blue signal and the luminance signal. Further, the image sensor need not be limited to the above CMOS type image sensor, but it is also possible to use other devices such as a CCD image sensor, etc.

On one of the flat surfaces of the substrate 52 is provided a supporting flat plate 52a that supports the above image sensor 51 and the outer tube 21, and a flexible circuit board 52b (FIG. 5) is provided whose one end part is connected to the supporting flat plate 52a.

The supporting flat plate 52a has provided on its surface a plurality of pads for signal transmission, which pads are connected to the wires W from the image sensor 51 described above and are also connected to the flexible circuit board 52b.

The flexible circuit board 52b, which has one of its end parts connected to the supporting flat plate 52a as described above, connects the supporting flat plate 52a and the external circuits (for example, the control circuits of a higher level apparatus in which the image taking apparatus is installed) via the terminals 54 for external connections provided on its other end part, receives from the external circuits the supply of power supply voltage or clock signals for driving the image sensor 51, and also makes it possible to output the digital YUV signals to the external circuits. In addition, the middle part along the longitudinal direction of the flexible printed circuit board 52b has flexibility or easy deformability, and because of its deformation, freedom has been provided in the orientation or placement of the external output terminals with respect to the supporting flat plate 52a.

The assembly frame 20 made of a light shielding member includes an outer tube 21 which is composed of a lower tube 21A which is placed so as to encircle the image sensor 51 and whose bottom end is adhered to the substrate 52 using an adhesive B, and an upper tube 21B with a short cylindrical shape which is mounted on the top part of the bottom tube 21A.

In FIG. 6, an IR cutoff filter F is mounted on the flange part 21a that extends from the internal circumference of the lower tube 21A in a direction perpendicular to the optical axis. Further, a stopper SP that is in contact with the supporting member 22e is placed on the top surface of the flange part 21a.

The moving tube 22, placed so as to be movable relative to the assembly frame 20, is constructed to have a large tubular part 22a, a small tubular part 22b coupled to its top end part, a small flange part 22c formed on its top end part, and a large flange part 22d that extends in the radial direction from the bottom end part of the large tubular part 22a, and furthermore a supporting member 22e has been provided that is installed so as to cover the large tubular part 22a, and it retains inside it the first lens L1, the second lens L2, the third lens L3, and the fourth lens L4 in that order from the object side. The central opening in the small flange part 22c becomes the aperture opening S.

The flange section L1f of the first lens L1 butts against and engages with the top part of the flange section L2f of the second lens L2 so as to enclose it. Further, the flange section L3f of the third lens L3 butts against and engages with the bottom part of the flange section L2f of the second lens L2 so as to enclose it. The external diameters of the first lens L1 and the second lens L2 are slightly smaller than the external diameters of the third lens L3. Therefore, as is described later, when the lenses L1 to L3 are assembled inside the small tubular part 22b so that first lens L1 butts against the small flange part 22c, the optical axis of the lens relative to the moving tube 22 is positioned with a high accuracy due to the mating between the internal circumferential surface of the small tubular part 22b and the external diameter of the third lens L3, and also because of the mating between the flange parts, the optical axis of the third lens L3 and the optical axes of the first lens L1 and the second lens L2 are positioned with a high accuracy.

On the other hand, as is described later, since the leg part L3g of the third lens L3 butts against and engages with the contacting surface L4p provided on the outer circumferential side of the fourth lens L4 which is the lens on the imaging side, the positioning can be done accurately of the optical axis of the fourth lens L4 with respect to the moving tube 22. The supporting member 22e has been affixed to the bottom surface of the flange part L4f of the fourth lens L4. In the present preferred embodiment, while the first lens L1 and the second lens L2 have rotationally symmetric cross-sections around the optical axis, the third lens L3 and the fourth lens L4 have rotationally asymmetric cross-sections around the optical axis.

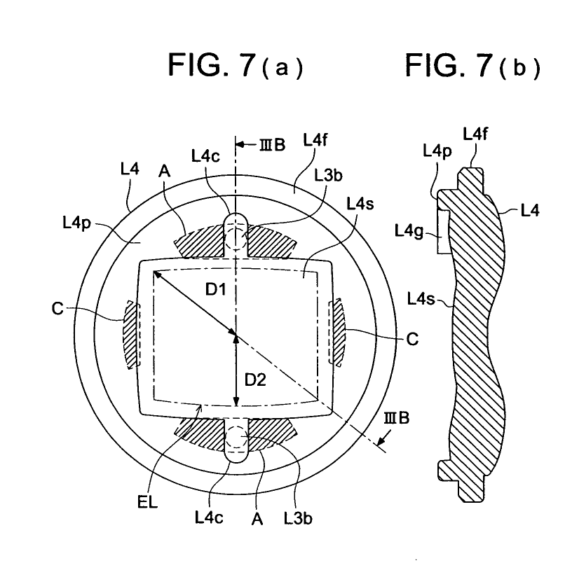

FIG. 7(a) is a diagram of the fourth lens L4 as viewed from the object side, and FIG. 7(b) is a diagram as seen in the direction of the arrow after cutting the fourth lens L4 of FIG. 7(a) in a plane containing the line IIIB-IIIB. The fourth lens L4, in the surface on the side of the subject of photography, forms a roughly rectangular shaped optical surface L4s in the periphery of the optical axis, and the contacting surface L4p is formed in the periphery of that optical surface L4s. Therefore, the inner circumference of the contacting surface L4p has a rough rectangular shape, its outer circumference has a cylindrical shape, and hence, the fourth lens L4 has a cross-section that is rotationally asymmetric around the optical axis. Further, in the contacting surface L4p, cuts L4c, L4c are formed at diagonally opposite two locations (top and bottom surfaces in FIG. 7(a)) so that it is connected to the inner circumference of the rectangular tube shape.

As is shown by the dotted line in FIG. 7(a), the effective light flux EL that is received by the rectangular shaped photoelectric conversion section (also called the light receiving surface) 51a of the image sensor 51 enters this optical surface L4s. Since the optical image formed outside the photoelectric conversion section 51a becomes unwanted light, the effective light flux EL has a roughly rectangular shape with a long side and a short side in a cross-sectional plane perpendicular to the optical axis. In a virtual plane perpendicular to the optical axis and passing through the contacting surface L4p, the maximum value of the distance from the optical axis to the outer edge of the effective light flux EL (referred to as the maximum distance) is taken as D1, and the minimum value of the distance from the optical axis to the outer edge of the effective light flux EL (referred to as the minimum distance) is taken as D2.

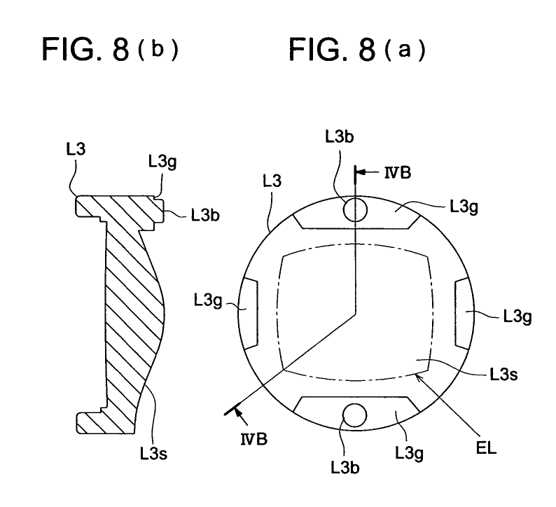

FIG. 8(a) is a diagram of the third lens L3 as viewed from the image side, and FIG. 8(b) is a diagram as seen in the direction of the arrow after cutting the third lens L3 of FIG. 8(a) in a plane containing the line IVB-IVB. In the image side face of the third lens L3, four leg parts L3g are formed on the circumference of the optical surface L3s. Further, at the center of the leg parts L3g at two opposite locations (above and below in FIG. 8(a)), bosses L3b, L3b with a cylindrical shape have been formed so as to project from the leg parts.

When the third lens L3 and the fourth lens L4 are assembled, although the four leg parts L3g butt against and come into contact with the contacting surface L4p, at this time, the bosses L3b, L3b of the third lens L3 mate with the cuts L4c, L4c of the fourth lens L4, and because of this, it is possible to prevent the rotation of the lenses L3 and L3 around the optical axis. Here, the contacting areas A and C between the leg parts L3g and the contacting surface L4p are shown hatched in FIG. 7(a). As is evident from FIG. 7(a), while the contacting area A in the direction of the short side of the effective light flux EL (the up-down direction in FIG. 7(a)), in the contacting surface L4p, is extending up to near the optical axis, in the contacting area C in the direction of the long side of the effective light flux EL (the left-right direction in FIG. 7(a)) is broken at a location far from the optical axis. In other words, a part of the contacting area A is positioned on the inside in a direction perpendicular to the optical axis relative to the position of the maximum distance D1 from the optical axis, and is also positioned on the outside in a direction perpendicular to the optical axis relative to the position of the minimum distance D2 from the optical axis. In other words, since a part of the contacting area A between the fourth lens L4 and the third lens L3 which is more towards the object side than it is positioned on the inside in a direction perpendicular to the optical axis relative to the position of the maximum distance D1 from the optical axis, it is possible to suppress the external diameter of the lens to a smaller value than this. In addition, since a part of the contacting area A is positioned on the outside in a direction perpendicular to the optical axis relative to the position of the minimum distance D2 from the optical axis, it is possible to form images with a high image quality without inhibiting the light beam incident on the photoelectric conversion section 51a. Further, the number and the shape of the leg parts L3g need not be restricted to the above but can be determined freely within a range in which the effectively light flux EL is not inhibited.

A tubular shaped actuator 30 has been placed on the outside in a direction perpendicular to the optical axis of the small tubular part 22b of the moving tube 22. The actuator 30 is constructed to have a tubular shaped coil 33 that is mounted on the large flange part 22d of the moving tube 22 and that has turns wound in the circumferential direction centering on the optical axis and extending in the direction of the optical axis, a cylindrical magnet 32 placed above the upper tube 21B so as to enclose the coil 33, and a cylindrical yoke 31 with its bottom end attached to the upper tube 21B so that it not only supports the magnet 32 but also covers the coil 33 from the above up to its inner circumference. Further, it is also possible to mount the magnet 32 to the moving tube 22 and to attach the coil 33 to the upper tube 21B.

A spring member 27, obtained by coupling donut-shaped circular plates with different diameters while shifting the phase of the coupling position, has its outer circumferential part fixed in the neighborhood of the bottom end of the upper tube 21B, and its inner circumferential part is fixed to the bottom surface of the supporting member 22e. On the other hand, the spring member 28 having a shape similar to the spring member 27 has its outer circumferential side fixed on the top surface of the yoke 31, and its inner circumferential side is fixed to the top end of the moving tube 22. The spring members 27 and 28 generate the biasing force according to the movement of the moving tube 22 in the direction of the optical axis.

The positive terminal of the coil 33 of the actuator 30 is connected to the spring member 27 via the wiring H1+ that passes through the large flange part 22d of the moving tube 22 and goes around the outer wall of the supporting member 22e. In addition, the spring member 27 is connected to the substrate 52 via the wiring H2+ that passes through the outer wall of the upper tube 21B and goes around the outer wall of the lower tube 21A. Further, the negative terminal of the coil 33 is connected to the spring member 28 via the wiring H1− that passes around the outer wall of the small tubular part 22b. The spring member 28 is connected to the substrate 52 via the wiring H2− that passes around the yoke 31, the upper tube 21B and the lower tube 21A. Although the principle of operation of driving a voice coil motor is omitted here because it is very widely known, because of the magnetic force generated due to electrical power supplied to the coil 33 from the outside via the spring members 27 and 28 and the wirings H1+, H2+, H1−, and H2−, the coil 33 can be displaced with respect to the magnet 32 according to the supplied electrical power.

The image taking lens 10 has, in order from the object side, an aperture opening S, a first lens L1 having a positive refractive index and a projecting surface on the object side, a second lens L2 having a negative refractive index, a third lens L3 having a positive refractive index, and a fourth lens L4 having a negative refractive index. In the present second preferred embodiment, although the lenses L1, L2, L3, and L4 constitute a focusing lens (also called a movable lens), since the external diameters of the lenses L1 to L3 have been made small compared to that of the lens L4, using this difference between the external diameters it has been made possible to install a large-sized actuator 30.

This image taking lens 10 carries out image formation of the photographed subject on the solid-state image sensor, while the aperture opening S and each of the lenses L1, L2, L3, and L4 all together constitute the optical system. The aperture opening S is a member that determines the F number of the overall imaging lens system.

The IR cutoff filter F held by the flange part 21a of the outer tube 21 in between the image taking lens 10 and the image sensor 51 is, for example, a member formed to have a rough rectangular shape or a circular shape.

In addition, it is also possible to place light shielding masks between the first lens L1 and the second lens L2, and between the second lens L2 and the third lens L3, and because of these, it is possible to prevent unwanted light entering outside the effective diameters of the lenses L3 and L4 that are near the solid-state image sensor, and to suppress the generation of ghosts or flare.

According to the second preferred embodiment, since the fourth lens L4 has an external diameter larger than the minimum internal diameter of the coil 33 of the actuator 30, it is possible to enlarge its effective diameter to an extent at which it is possible to obtain sufficient optical characteristics. Further, because the lenses L1 to L3 other than the fourth lens L4 have been placed on the inside in a direction perpendicular to the optical axis, and since the actuator 30 can be positioned using the differences between the diameter of the fourth lens L4 and the diameters of the lenses L1 to L3, it is possible to increase the driving force because it is possible to increase either the number of turns in the coil 33 or the length of the coil 33.

According to the second preferred embodiment of the present invention, since said lens closest to the image side has an external diameter larger than the minimum internal diameter of the yoke of the actuator, it is possible to enlarge its effective diameter to an extent at which it is possible to obtain sufficient optical characteristics. Further, because said movable lenses other than said lens closest to the image side have been placed on the inside of said internal diameter in a direction perpendicular to the optical axis, and since the actuator can be positioned using the differences between the diameter of said lens closest to the image side and the diameters of said movable lenses other than that lens, it is possible to increase the driving force because it is possible to increase either the number of turns in the coil or the length of the coil.

Further, according to the second preferred embodiment of the present invention, considering that the light receiving surface of said solid-state image sensor has a rectangular shape, said lens closest to the image side and the contacting parts with the lenses closer than it to the object side have been positioned as far as possible on the inside in a direction perpendicular to the optical axis, within a range in which the effective light flux incident on said light receiving surface is not inhibited. In more concrete terms, since at least one part among the contacting parts between said imaging side lens closest to the image side and the lens towards the object side from it is positioned, in a plane passing through that contacting part but perpendicular to the optical axis, more towards the inside in a direction perpendicular to the optical axis than the maximum value up to the outer edge of the effective light flux of said image taking lens entering the light receiving surface of said solid-state image sensor from the optical axis, it is possible to suppress the external diameter of the lens to a small value. Further, since at least one part among said contacting parts is positioned, in a plane perpendicular to the optical axis but passing through said contacting part, more towards the outside in a direction perpendicular to the optical axis than the minimum value of the effective light flux of said image taking lens entering the light receiving surface of said solid-state image sensor from the optical axis, it is possible to form images with the high image quality without inhibiting the light flux incident on the light receiving plane.

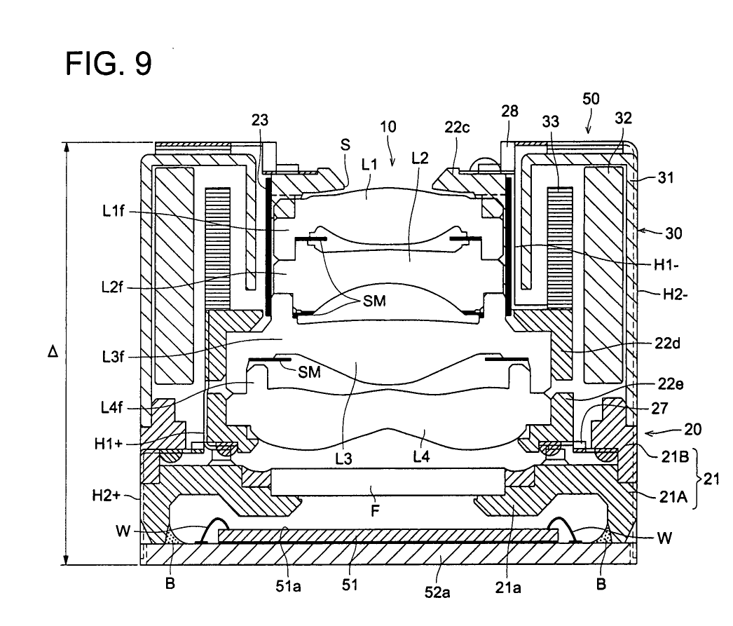

Next, a third preferred embodiment of the present invention is described here with reference to the drawings. Since the perspective view diagram of the image taking apparatus according to the third preferred embodiment is common with that of the first preferred embodiment, explanations are given here using FIG. 1. Further, explanations of configurations common with the first preferred embodiment are omitted here. FIG. 9 is a diagram as seen in the direction of the arrow after cutting the image taking apparatus 50 of FIG. 1 according to the third preferred embodiment in a plane containing the line I-I.

In FIG. 9, an IR cutoff filter F is mounted on the flange part 21a that extends from the internal circumference of the lower tube 21A in a direction perpendicular to the optical axis.

The first lens L1, the second lens L2, the third lens L3, and the fourth lens L4 are placed as the variable lens in this order on the inside in a direction perpendicular to the optical axis of the assembly frame 20.

The flange section L1f of the first lens L1 butts against and engages with the top part of the flange section L2f of the second lens L2 so as to enclose it. Further, the flange section L3f of the third lens L3 butts against and engages with the bottom part of the flange section L2f of the second lens L2 so as to enclose it. In addition, the bottom part of the flange section L3f of the third lens L3 butts against and engages with the flange section L4f of the fourth lens L4 so as to enclose it. In this manner, by mutually coupling the lenses L1 to L4, not only shifts in the optical axis are prevented without having to use a mirror frame, but also the spacing between the lenses is being set with a good accuracy.

A flange member 22c having an opening at the center that defines the aperture opening S is affixed to the flange section L1f of the first lens L1. A first supporting member 22d is affixed to the flange section L3f of the third lens L3. A second supporting member 22e is affixed to the bottom surface of the flange section L4f of the fourth lens L4. As is clear from FIG. 2, the flange member 22c, the first supporting member 22d, and the second supporting member 22e have not been coupled rigidly and do not have the function of a mirror frame. Further, a thin cylindrical shaped light shielding sheet 23 has been provided between the flange member 22c and the first supporting member 22d, thereby suppressing the incidence of unwanted light from outside.

A cylindrical shaped actuator 30 has been placed on the outside of the lenses L1 to L3 in a direction perpendicular to the optical axis. The actuator 30 is constructed to have a coil 33 that is affixed to the first supporting member 22d and extending in the direction of the optical axis, a magnet 32 placed above the upper tube 21B so as to enclose the coil 33, and a yoke 31 with its bottom end affixed to the upper tube 21B so that it not only supports the magnet 32 but also covers the coil 33 from above up to its inner circumference. The inner circumference of the yoke 31 is facing the outer circumference of the lenses L1 to L3 via the light shielding sheet 23. Further, it is also possible to mount the magnet 32 to the first supporting member 22d and to attach the coil 33 to the upper tube 21B.

A spring member 27, obtained by coupling donut-shaped circular plates with different diameters while shifting the phase of the coupling position, has its outer circumferential part fixed in the neighborhood of the bottom end of the upper tube 21B, and its inner circumferential part is fixed to the bottom surface of the second supporting member 22e. On the other hand, the spring member 28 having a shape similar to the spring member 27 has its outer circumferential side fixed on the top surface of the yoke 31, and its inner circumferential side is fixed to the top surface of the flange member 22c. The spring members 27 and 28 generate the biasing force according to the movement of the lenses L1 to L4 in the direction of the optical axis.

The positive terminal of the coil 33 of the actuator 30 is connected to the spring member 27 via the wiring H1+ that passes through the first supporting member 22d and goes around the outer wall of the second supporting member 22e. In addition, the spring member 27 is connected to the substrate 52 via the wiring H2+ that passes through the outer wall of the upper tube 21B and goes around the outer wall of the lower tube 21A. Further, the negative terminal of the coil 33 is connected to the spring member 28 via the wiring H1− that passes around the outer wall of the light shielding sheet 23. The spring member 28 is connected to the substrate 52 via the wiring H2− that passes around the yoke 31, the upper tube 21B and the outer wall of the lower tube 21A. Although the principle of operation of driving a voice coil motor is omitted here because it is very widely known, because of the magnetic force generated due to the electrical power supplied to the coil 33 from the outside via the spring members 27 and 28 and the wirings H1+, H2+, H1−, and H2−, the coil 33 can be displaced with respect to the magnet 32 according to the supplied electrical power.

The image taking lens 10 has, in sequence from the object side, an aperture opening S, a first lens L1 having a positive refractive index and a projecting surface on the object side, a second lens L2 having a negative refractive index, a third lens L3 having a positive refractive index, and a fourth lens L4 having a negative refractive index. In the present preferred embodiment, although the lenses L1, L2, L3, and L4 constitute a focusing lens (also called a movable lens), since the external diameters of the lenses L1 and L2 have been made small compared to that of the lenses L3 and L4, using this difference between the external diameters it has been made possible to install a large-sized actuator 30.

This image taking lens 10 carries out image formation of the photographed subject on the solid-state image sensor, while the aperture opening S and each of the lenses L1, L2, L3, and L4 all together constitute the optical system. The aperture opening S is a member that determines the F number of the overall imaging lens system.

The IR cutoff filter F held by the flange part 21a of the outer tube 21 in between the image taking lens 10 and the image sensor 51 is, for example, a member formed to have a rough rectangular shape or a circular shape.

In addition, light shielding masks SM are placed between the first lens L1 and the second lens L2, between the second lens L2 and the third lens L3, and between the third lens L3 and the fourth lens L4, and because of these, it is possible to prevent unwanted light outside the effective diameter of the lens L4 from entering near the solid-state image sensor, and thus to suppress the generation of ghosts or flare.

According to the third preferred embodiment of the present invention, since the four lenses L1 to L4 forming the movable lens are coupled to each other, there is no need to provide a mirror frame that encloses and holds these lenses L1 to L4, and because of this, it is possible to use efficiently the space on the outside the lenses L1 to L4 in a direction perpendicular to the optical axis, and by placing the actuator in that space, it is possible to increase either the number of turns in or the length of the coil 33, and hence it is possible to increase the driving force. Further, it is sufficient if the coupled lenses are at least two or more.

Further, in the third preferred embodiment, since the flange sections are butted and engaged with each other in said coupled lenses, it is possible to suppress shifts of the optical axis in said coupled lenses, and to set the distances between the lenses with a good accuracy.

Further, in the third preferred embodiment, since a light shielding sheet is placed between said coupled lenses and said actuator it is possible to suppress unwanted light from the outside entering inside the lenses.

In the third preferred embodiment, further, since said movable lens is formed from four lenses and since at least a part of said actuator has been placed on the outside of the three lenses excluding the lens that is closest to the image side in a direction perpendicular to the optical axis, while it is possible to acquire a wide space in the periphery of said coupled lenses while maintaining the optical characteristics, it is also good if said movable lens is one having three or more, or five or more lenses.

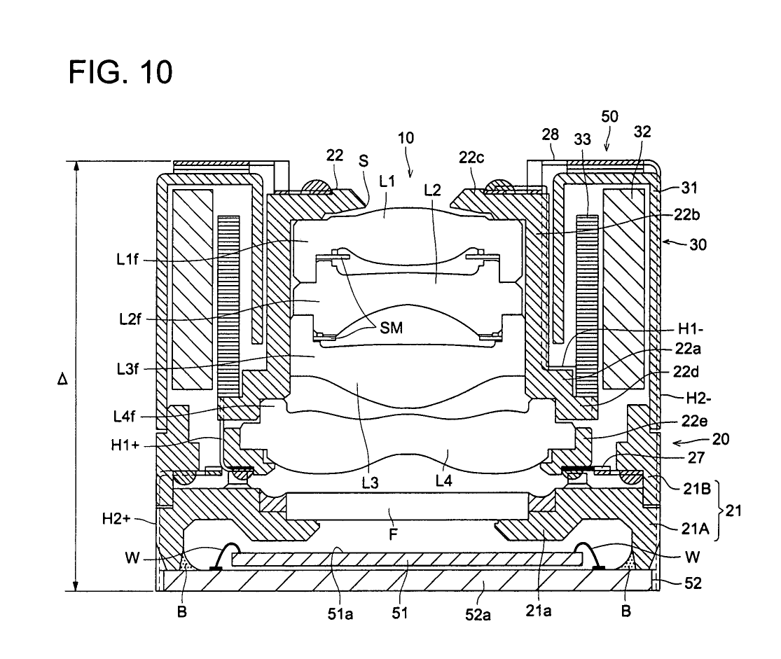

Next, a fourth preferred embodiment of the present invention is described here with reference to the drawings. Since the perspective view diagram of the image taking apparatus according to the fourth preferred embodiment is common with that of the first preferred embodiment, explanations are given here using FIG. 1. Further, explanations of configurations common with the first preferred embodiment are omitted here. FIG. 10 is a diagram as seen in the direction of the arrow after cutting the image taking apparatus 50 of FIG. 1 according to the fourth preferred embodiment in a plane containing the line I-I.

In FIG. 10, an IR cutoff filter F is mounted on the flange part 21a that extends from the internal circumference of the lower tube 21A in a direction perpendicular to the optical axis.

The moving tube 22, placed so as to be movable relative to the assembly frame 20, is constructed to have a large tubular part 22a, a small tubular part 22b coupled to its top end part, a small flange part 22c formed on its top end part, and a large flange part 22d that extends in the radial direction from the bottom end part of the large tubular part 22a, and a supporting member 22e that is installed so as to cover the large tubular part 22a, and this moving tube 22 retains inside it the first lens L1, the second lens L2, the third lens L3, and the fourth lens L4 in that order from the object side. The central opening in the small flange part 22c becomes the aperture opening S.

The flange section L1f of the first lens L1 butts against and engages with the top part of the flange section L2f of the second lens L2 so as to enclose it. Further, the flange section L3f of the third lens L3 butts against and engages with the bottom part of the flange section L2f of the second lens L2 so as to enclose it. The external diameters of the first lens L1 and the second lens L2 are slightly smaller than the external diameters of the third lens L3. Therefore, when the lenses L1 to L3 are assembled inside the small tubular part 22b so that the first lens L1 butts against the small flange part 22c, the optical axis of the lens relative to the moving tube 22 is positioned with a high accuracy due to the mating between the internal circumferential surface of the small tubular part 22b and the external diameter of the third lens L3, and also because of the mating between the flange parts, the optical axis of the third lens L3 and the optical axes of the first lens L1 and the second lens L2 are positioned with a high accuracy.

On the other hand, since the flange section L4f of the fourth lens L4 which is the lens closest to the imaging side butts against and engages with the inner circumference of the large tubular part 22a, because of this, the positioning can be done accurately of the optical axis of the fourth lens L4 with respect to the moving tube 22. The supporting member 22e has been affixed to the bottom surface of the flange section L4f of the fourth lens L4.

A tubular shaped actuator 30 has been placed on the outside in a direction perpendicular to the optical axis of the small tubular part 22b of the moving tube 22. The actuator 30 is constructed to have a tubular shaped coil 33 that is affixed to the large flange part 22d of the moving tube 22 and that has turns wound in the circumferential direction centering on the optical axis and extending in the direction of the optical axis, a cylindrical magnet 32 placed above the upper tube 21B so as to enclose the coil 33, and a cylindrical yoke 31 with its bottom end attached to the upper tube 21B so that it not only supports the magnet 32 but also covers the coil 33 from above up to its inner circumference. Further, it is also possible to attach the magnet 32 to the moving tube 22 and to attach the coil 33 to the upper tube 21B.

A spring member 27, obtained by coupling donut-shaped circular plates with different diameters while shifting the phase of the coupling position, has its outer circumferential part fixed in the neighborhood of the bottom end of the upper tube 21B, and its inner circumferential part is fixed to the bottom surface of the supporting member 22e. On the other hand, the spring member 28 having a shape similar to the spring member 27 has its outer circumferential side fixed on the top surface of the yoke 31, and its inner circumferential side is fixed to the top end of the moving tube 22. The spring members 27 and 28 generate the biasing force according to the movement of the moving tube 22 in the direction of the optical axis.

The positive terminal of the coil 33 of the actuator 30 is connected to the spring member 27 via the wiring H1+ that passes through the large flange part 22d of the moving tube 22 and goes around the outer wall of the supporting member 22e. In addition, the spring member 27 is connected to the substrate 52 via the wiring H2+ that passes through the outer wall of the upper tube 21B and goes around the outer wall of the lower tube 21A. Further, the negative terminal of the coil 33 is connected to the spring member 28 via the wiring H1− that passes around the outer wall of the small tubular part 22b. The spring member 28 is connected to the substrate 52 via the wiring H2− that passes around the yoke 31, the upper tube 21B and the lower tube 21A. Although the principle of operation of driving a voice coil motor is omitted here because it is very widely known, because of the magnetic force generated due to electrical power supplied to the coil 33 from the outside via the spring members 27 and 28 and the wirings H1+, H2+, H1−, and H2−, the coil 33 can be displaced with respect to the magnet 32 according to the supplied electrical power.

The image taking lens 10 has, in order from the object side, an aperture opening S, a first lens L1 having a positive refractive index and a projecting surface on the object side, a second lens L2 having a negative refractive index, a third lens L3 having a positive refractive index, and a fourth lens L4 having a negative refractive index. In the present preferred embodiment, although the lenses L1, L2, L3, and L4 constitute a focusing lens (also called a movable lens), since the external diameters of the lenses L1 to L3 have been made small compared to that of the lens L4, using this difference between the external diameters it has been made possible to install a large-sized actuator 30.

This image taking lens 10 carries out image formation of the photographed subject on the solid-state image sensor, while the aperture opening S and each of the lenses L1, L2, L3, and L4 all together constitute the optical system. The aperture opening S is a member that determines the F number of the overall imaging lens system.

The IR cutoff filter F held by the flange part 21a of the outer tube 21 in between the image taking lens 10 and the image sensor 51 is, for example, a member formed to have a rough rectangular shape or a circular shape.

In addition, light shielding masks SM are placed between the first lens L1 and the second lens L2, and between the second lens L2 and the third lens L3, and because of these, it is possible to prevent unwanted light outside the effective diameters of the lenses L3 and L4 from entering near the solid-state image sensor, and to suppress the generation of ghosts or flare.

According to the fourth preferred embodiment, since the fourth lens L4 has an external diameter larger than the minimum internal diameter of the coil 33 of the actuator 30, it is possible to enlarge its effective diameter to an extent at which it is possible to obtain sufficient optical characteristics. Further, because the lenses L1 to L3 other than the fourth lens L4 have been placed on the inside in a direction perpendicular to the optical axis, and since the actuator 30 can be positioned using the differences between the diameter of the fourth lens L4 and the diameters of the lenses L1 to L3, it is possible to increase the driving force because it is possible to increase either the number of turns in the coil 33 or the length of the coil 33.

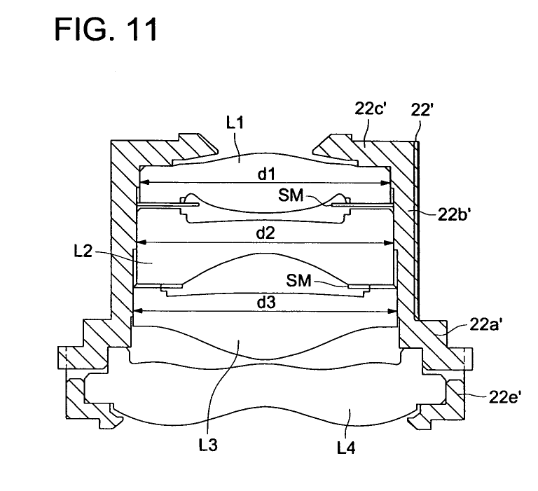

FIG. 11 is a cross-sectional view diagram of a moving tube and a movable lens according to a modified example of the fourth preferred embodiment. In this modified example, the flange sections of the lenses L1′ to L3′ are not mating with each other. Instead of that, the internal diameter of the small tubular part 22b′ of the moving tube 22′ is becoming smaller in steps towards the top (the image side). In other words, the small tubular part 22b′ has a shape in which its internal diameter increases as internal diameter d1, internal diameter d2, and internal diameter d3 sequentially starting from the part closest to the small flange section 22c′. In addition, the external diameter d1 of the lens L1′, the external diameter d2 of the lens L2′, and the external diameter d3 of the lens L3′ are set so that they have successively increasing magnitudes.

By matching the diameters in this manner, when the lenses L1′ to L3′ are assembled inside the small tubular part 22b′, since each of them can be mated without any play, it is possible to position the optical axes of the lenses L1′ to L3′ with respect to the moving tube 22′ with a good accuracy. In addition, it is desirable that the lenses L1′ to L3′ mate only in one part with the corresponding internal diameter of the small tubular part 2b′ (that is, so that they project outwards in a direction perpendicular to the optical axis). Since the rest of the construction including the fourth lens L4 is identical to that of the fourth preferred embodiment described above, their description is omitted here.

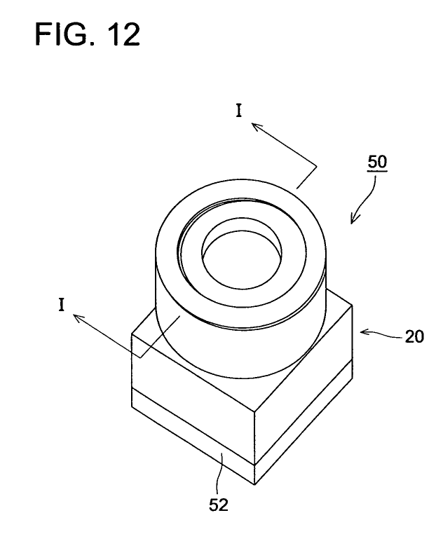

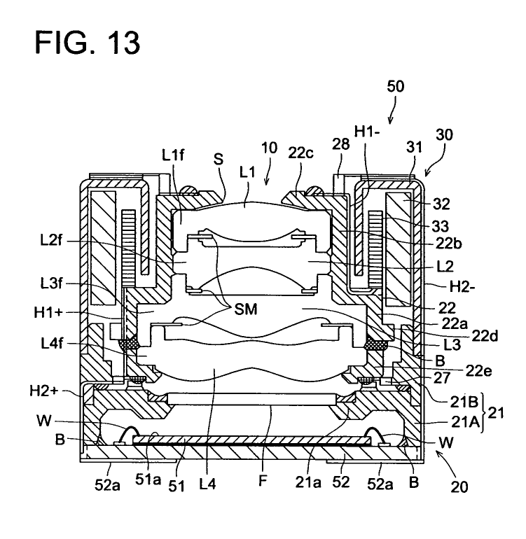

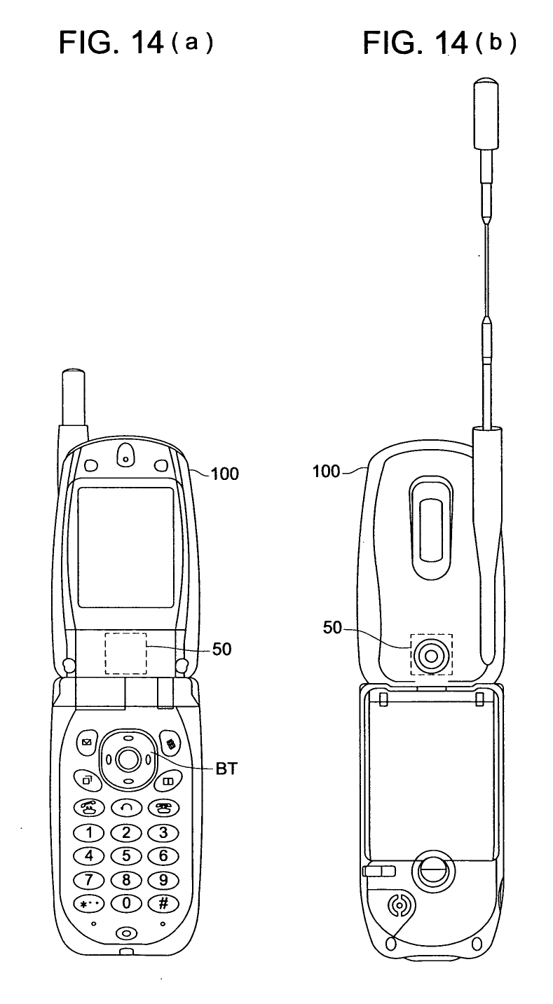

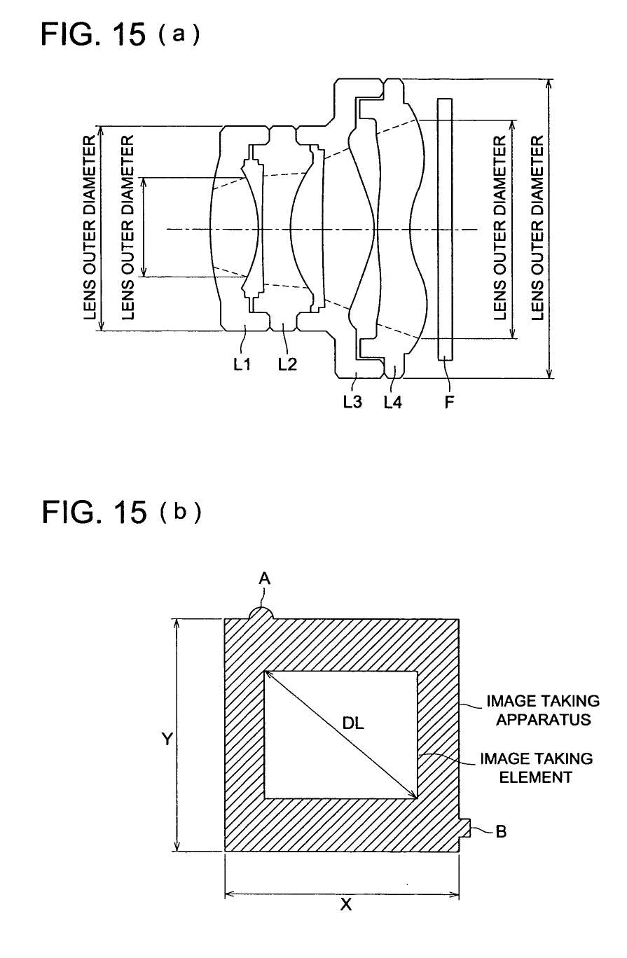

Next, a fifth preferred embodiment of the present invention is described here with reference to the drawings. FIG. 12 is a perspective view diagram of an image taking apparatus 50 according to the fifth preferred embodiment. FIG. 13 is a diagram as seen in the direction of the arrow after cutting the image taking apparatus 50 of FIG. 12 in a plane containing the line I-I. FIG. 14 is a drawing showing the state in which the image taking apparatus 50 has been installed in a mobile telephone unit 100 used as a portable terminal. FIG. 15(a) is a diagram for explaining the effective diameter of the image taking lens. FIG. 15(b) is a diagram for explaining the values of the condition equations (1) and (2).

The image taking apparatus according to the fifth preferred embodiment of the present invention is an image taking apparatus comprising: a frame; an image taking lens that includes at least one movable lens that can be moved in a direction of the optical axis of the image taking lens with respect to said frame; a lens frame that supports the movable lens; an actuator for moving the movable lens; a solid-state image sensor; a substrate which holds the solid-state image sensor and includes a terminal for the external connection for sending and receiving electric signal; a movable frame that is coupled to a movable element of said actuator; and a casing formed of a light shielding member fixed to the substrate in such a manner to surround the periphery of the solid-state image sensor and the image taking lens; wherein the lens frame and the movable frame are formed integrally and wherein when the size of the image taking apparatus in the direction of the long side of the image sensor rectangular effective pixel area is taken as X, and the size of image taking apparatus in the direction of the short side of the image sensor rectangular effective pixel area is taken as Y, and the length of the diagonal line of the rectangular effective pixel area of the solid-state image sensor is taken as DL, the image taking apparatus satisfies the conditions of
1.5<X/DL<2.0 (1)
2.5<Y/DL<2.0 (2),
and wherein the image taking lens includes a plurality of lenses where the most image side lens of the plurality of lenses has an effective diameter larger than the effective diameters of the other lenses of the plurality of lenses, and wherein the actuator, at least a part of which is arranged in a space generated in the minimum effective diameter lens periphery by the difference of the outer diameter of the minimum effective diameter lens in the plurality of lenses and the outer diameter of the maximum effective diameter lens in the plurality of lenses, is arranged for driving a focusing lens group of the image taking lens which is driven at a time of focusing and the maximum value of the drive current of the actuator is 50 mA or more but no more than 200 mA.

In addition, when the value X/DL and the value Y/DL are less than the upper limits of the condition equations (1) and (2), it is possible to realize a compact size similar to that of an image taking apparatus of the fixed focus type that does not have any focusing function, and because of this, it is possible to incorporate an image taking apparatus with auto focus function in a compact apparatus such as a mobile telephone unit. In addition, when the value X/DL and the value Y/DL are more than the lower limits of the condition equations (1) and (2), it becomes easy to acquire the space for wire bonding in the neighborhood at the time of installing the solid-state image sensor or for bonding together the frame and the substrate. In the present invention, in spite of being an image taking apparatus having the focusing function, in order to realize a small size that satisfies the conditional equations (1) and (2), an actuator for driving the group of focusing lenses is placed in the neighboring part of the lens with the smallest external diameter.

When the focusing lens group is a part of the image taking lens, compared to the case of moving the entire image taking lens, it is possible to reduce the weight of the focusing lens group, and hence it is possible to suppress the electric power consumption required for driving the lens movement. In addition, when the focusing lens is the entire image taking lens, unlike the configuration of moving a part of the lens, it is possible to simplify the structure for making the performance degradation small due to the error in the inclination of the focusing lens group during focusing or the error in the shift along a direction perpendicular to the optical axis, and for guiding the focusing lens group along a straight line.

However, in order to obtain a small sized image taking apparatus satisfying the condition equations (1) and (2), it is necessary to use a compact actuator as said actuator. Here, the reason for taking 50 mA as the lower limit value of the appropriate range of the maximum value of the drive current of said actuator is because this is the current value necessary for obtaining the driving force for the auto-focusing operation of the lens for focusing using a small sized actuator. In general, since the driving force for the supplied electrical current is small in the case of a small sized actuator, in order to obtain the necessary driving force, it is necessary to increase the drive current more than in a normal actuator. In other words, using a drive current with a value of the maximum drive current less than 50 mA, it is not possible to obtain the driving force necessary for driving the lens for focusing (for example, the necessary drive stroke cannot be obtained in the case of a voice coil motor), or, even if the driving is possible, the movement becomes slow and there is the likelihood of problems occurring such as not being able to grasp photographing opportunities.

On the other hand, if the current value is increased, there is also the trend that heat generation in the actuator also increases accordingly. In particular, in an image taking apparatus satisfying the conditions (1) and (2), because its volume is small, it is easy for the temperature inside the apparatus to increase, and further, when lenses made of plastic are used, there is the possibility of problems occurring such as the lens performance characteristics getting degraded due to heat. The reason for taking 200 mA as the upper limit value of the appropriate range of the maximum value of the drive current of said actuator is that this is the maximum current value at which it is possible to drive the actuator in a condition in which the degradation in the performance characteristics of the lens caused by heat is suppressed to a level that does not affect photographing. Further, although there is no problem even if the maximum current of 200 mA is supplied for a short time, when supplying the current for a long time period, it is desirable that this upper limit value is made 100 mA.

Here, a minimum effective diameter lens is a lens with the smallest effective diameter, when the effective diameters of the different lenses are compared using the larger diameter among the effective diameters of the object side surface and the image side surface of each of the lenses (the distance from the optical axis to the maximum peripheral light ray of the light flux passing through that surface contributing to image formation is called the effective radius, and twice that value is called the effective diameter). For example, in the example of the image taking lens shown in FIG. 15(a), the first lens L1 is the minimum effective diameter lens, and the fourth lens L4 is the maximum effective diameter lens. In addition, a lens external diameter is the external diameter including the flange section around the effective diameter.

As is shown in FIG. 15(b), when a photograph is taken of the image taking apparatus while pointing towards the substrate on which the image sensor has been mounted, the condition equations (1) and (2) are stipulated taking the size of the image taking apparatus in the direction of the long side of the image sensor rectangular effective pixel area as X, and taking the size of the image taking apparatus in the direction of short side of the image sensor rectangular effective pixel area as Y. Here, although X and Y are taken as the maximum values of the image taking apparatus in the respective directions, the flexible printed circuit board connected to the image taking apparatus, the small projections (A) formed on the outer wall of the image taking apparatus and used during the assembly process, and additional components (B) affixed on the outer wall, etc., are not included at the time of determining the size. When the effective pixel area of the solid-state image sensor is not rectangular, the values of X and Y are determined by approximating that shape into a rectangle.

The above image taking apparatus 50 is provided with a CMOS type image sensor 51 as a solid-state image sensor having a photoelectric conversion section 51a, an image taking lens 10 that forms an image of the photographed subject on the photoelectric conversion section 51a of this image sensor 51, an IR cutoff filter F placed between the image sensor 51 and the image taking lens 10, a substrate 52 that not only supports the image sensor 51 but also has on its back surface the terminals 52a for external connections that carries out the transmission and reception of its electrical signals, an assembly frame 20 that supports the image taking lens 10, and an actuator 30 (also called a focusing actuator) made of a voice coil motor that drives the focusing lens group, and all of these are formed in an integral manner. Further, the height C in the direction of the optical axis of this image taking apparatus 50 is 10 mm or less.

The above image sensor 51 has formed at the center of the flat surface on its light receiving side a photoelectric conversion section 51a as the light receiving section in which the pixels (photoelectric conversion devices) are arranged in a two-dimensional array, and a logic section (not shown in the figure) is formed in the region surrounding it. This logic section is configured to include signal processing circuits, etc., for outputting signals of a prescribed format (for example, YUV signals or RGB signals). In addition, in the neighborhood of the outer edge of the flat surface on the light receiving side of the image sensor 51, a plurality of pads (not shown in the figure) are placed and are connected to the substrate 52 through wires. The image sensor 51 converts the signal charge from the photoelectric conversion section 51a into image signals such as digital YUV signals, etc., and outputs them to the specific circuits on the substrate 52 via the wires W. Further, the image sensor need not be limited to the above CMOS type image sensor, but it is also possible to use other devices such as a CCD image sensor, etc.

The substrate 52 has provided on its back surface a plurality of pads for transmitting signals, and these pads are connected to the wires W from the image sensor described above, and are also connected to terminals 52a for external connections.

The substrate 52 makes it possible to connect with external circuits (for example, the control circuits of a higher level apparatus in which the image taking apparatus is installed) via the terminals 52a for external connections provided, receives from the external circuits the supply of power supply voltage or clock signals for driving the image sensor 51, and also, to output signals with a prescribed format to the external circuits.

The assembly frame 20, made of a light shielding member and placed in the periphery of the image taking lens 10, includes an outer tube 21, which is composed of a lower tube 21A which is placed so as to enclose the image sensor 51 and whose bottom end is adhered to the substrate 52 using an adhesive B, and a short cylindrical shaped upper tube 21B which is mounted on the top part of the bottom tube 21A.

In FIG. 13, an IR cutoff filter F is mounted on the flange part 21a that extends from the internal circumference of the lower tube 21A in a direction perpendicular to the optical axis.

The moving tube 22, placed so as to be movable relative to the assembly frame 20, is constructed to have a large tubular part 22a, a small tubular part 22b coupled to its top end part, a small flange part 22c formed on its top end part, and a large flange part 22d that extends in the radial direction from the bottom end part of the large tubular part 22a, and a supporting member 22e that has been adhered using an adhesive B so as to cover the large tubular part 22a, and internally holds in a fixed manner the first lens L1, the second lens L2, the third lens L3, and the fourth lens L4, in that order from the object side. The central opening in the small flange part 22c becomes the aperture opening S.

The flange section L1f of the first lens L1 butts against and engages with the top part of the flange section L2f of the second lens L2 so as to enclose it. Further, the flange section L3f of the third lens L3 butts against and engages with the bottom part of the flange section L2f of the second lens L2 so as to enclose it. In addition, the flange section L4f of the fourth lens L4 butts against and engages with the bottom part of the flange section L3f of the third lens L2 so as to enclose it. The external diameters of the first lens L1 and the second lens L2 are slightly smaller than the external diameters of the third lens L3. Therefore, when the lenses L1 to L3 are assembled inside the small tubular part 22b so that the first lens L1 butts against and engages with the small flange part 22c, the optical axis of the lens relative to the moving tube 22 is positioned with a high accuracy due to the mating between the internal circumferential surface of the small tubular part 22b and the external diameter of the flange section L3f of the third lens L3, and also, because of the mating between the flange parts, the optical axis of the third lens L3 and the optical axes of the first lens L1 and the second lens L2 are positioned with a high accuracy. The optical axis of the fourth lens L4 is positioned with a high accuracy with the optical axis of the third lens L3 because of the mating between the flange sections.

A tubular shaped actuator 30 has been placed on the outside in a direction perpendicular to the optical axis of the small tubular part 22b of the moving tube 22. The actuator 30 is constructed to have a tubular shaped coil 33 that is attached to the large tubular part 22a of the moving tube 22 and that extends in the direction of the optical axis, a magnet 32 placed above the upper tube 21B so as to enclose the coil 33, and a yoke 31 with its bottom end attached to the upper tube 21B so that it not only supports the magnet 32 but also covers the coil 33 from above up to its inner circumference. Further, it is also possible to mount the magnet 32 to the moving tube 22 and to attach the coil 33 to the upper tube 21B.

A spring member 27, obtained by coupling donut-shaped circular plates with different diameters while shifting the phase of the coupling position, has its outer circumferential part fixed in the neighborhood of the bottom end of the upper tube 21B, and its inner circumferential part is fixed to the bottom surface of the supporting member 22e. On the other hand, the spring member 28 having a shape similar to the spring member 27 has its outer circumferential side fixed on the top surface of the yoke 31, and its inner circumferential side is fixed to the top end of the moving tube 22. The spring members 27 and 28 generate the biasing force according to the movement of the moving tube 22 in the direction of the optical axis.

The positive terminal of the coil 33 of the actuator 30 is connected to the spring member 27 via the wiring H1+ that passes through the large flange part 22d of the moving tube 22 and goes around the outer wall of the supporting member 22e. In addition, the spring member 27 is connected to the substrate 52 via the wiring H2+ that passes through the outer wall of the upper tube 21B and goes around the outer wall of the lower tube 21A. Further, the negative terminal of the coil 33 is connected to the spring member 28 via the wiring H1− that passes around the outer wall of the small tubular part 22b. The spring member 28 is connected to the substrate 52 via the wiring H2− that passes around the yoke 31, the upper tube 21B and the lower tube 21A. Although the principle of operation of driving a voice coil motor is omitted here because it is very widely known, because of the magnetic force generated due to electrical power supplied to the coil 33 from the outside via the spring members 27 and 28 and the wirings H1+, H2+, H1−, and H2−, the coil 33 can be displaced with respect to the magnet 32 according to the supplied electrical power. At this time, the maximum value of the drive current passed through the coil 33 has been set within the range of 50 mA or more but 200 mA or less.

The image taking lens 10 has, in order from the object side, an aperture opening S, a first lens (minimum effective diameter lens) L1 having a positive refractive index and a projecting surface on the object side, a second lens L2 having a negative refractive index, a third lens L3 having a positive refractive index, and a fourth lens (maximum effective diameter lens) L4 having a negative refractive index. In the present preferred embodiment, although the lenses L1, L2, L3, and L4 constitute a focusing lens group (also called a movable lens), since the external diameters of the lenses L1 and L2 have been made small compared to that of the lens L4, using this difference between the external diameters it has been made possible to install a large-sized actuator 30.

This image taking lens 10 is for carrying out image formation of the photographed subject on the solid-state image sensor, while the aperture opening S and each of the lenses L1, L2, L3, and L4 all together constitute the optical system. The aperture opening S is a member that determines the F number of the overall imaging lens system.

The IR cutoff filter F held by the flange part 21a of the outer tube 21 in between the image taking lens 10 and the image sensor 51 is, for example, a member formed to have a rough rectangular shape or a circular shape.

In addition, light shielding masks SM are placed between the first lens L1 and the second lens L2, and between the second lens L2 and the third lens L3, and because of these, it is possible to prevent unwanted light outside the effective diameters of the lenses L3 and L4 from entering near the solid-state image sensor, and to suppress the generation of ghosts or flare.

According to the fifth preferred embodiment, since the yoke 31 of the actuator 30 has been positioned in the space generated due to the difference in the external diameter of the first lens L1 and the external diameters of the second lens L2 and the fourth lens L4. It is possible to increase the number of turns or the length of the coil, and hence to increase the driving force.

The mode of use of the image taking apparatus 50 described above is explained here. FIG. 14 is a drawing showing the state in which the image taking apparatus 50 has been installed in a mobile telephone unit 100 used as a portable terminal. As is shown in FIG. 14, regarding the configuration of the image taking apparatus 50, since only the configurations of the flexible substrate 52b and the terminals for external connections in FIG. 1 are different from those in the first preferred embodiment, explanations of common configurations are omitted. Further, since even the control block diagram of the mobile telephone unit 100 is common with the configuration of the first preferred embodiment, its explanation is omitted here.

The image taking apparatus 50 is, for example, installed so that the object side end surface of the outer tube 21 in the image taking lens is on the back surface of the mobile telephone unit 100 (the liquid crystal display section side is taken as the front side) at a position corresponding to below the liquid crystal display section.

The terminals 52a for external connections of the image taking apparatus 50 are connected to the control section 101 of the mobile telephone unit 100, and output the image signals such as the luminance signal and the color difference signals, etc., to the control section 101.

In the fifth preferred embodiment, the “space generated in the periphery of the minimum effective diameter lens due to the difference between the external diameter of the minimum effective diameter lens and the external diameter of the maximum effective diameter lens” includes the “space generated in the periphery of the minimum effective diameter lens as a result of the difference between the external diameter of the minimum effective diameter lens and the external diameter of the maximum effective diameter lens”, and for example, in the case when both the minimum effective diameter lens and the maximum effective diameter lens are being held by supporting members, the space generated in the periphery of the minimum effective diameter lens due to the difference between the external diameters of those supporting members corresponds to the “space generated in the periphery of the minimum effective diameter lens due to the difference between the external diameter of the minimum effective diameter lens and the external diameter of the maximum effective diameter lens”.

According to the fifth preferred embodiment, since the maximum value of the drive current applied to the coil 33 has been restricted to the range from more than 50 mA to 200 mA or less, it is possible not only to obtain the driving force necessary for driving the lenses L1 to L4 speedily, but also to suppress the generation of heat that can cause deterioration in the optical characteristics of the lenses L1 to L4.

Further, it is possible to form the lenses L1 to L4 from glass or a plastic material. Here, since plastic materials have a larger change in the refractive index with changes in the temperature compared to glass materials, if the entire lens is made of plastic lenses, even if the change in the temperature is relatively small, the problem occurs that the position of the imaging point of the entire lens system in the image taking lens changes. However, since the image taking apparatus according to the present invention has the auto focus mechanism, although this does not cause any difficulties during normal use, since it is necessary to include beforehand the amount of movement of the focusing lens by the amount of change of the imaging point, this leads to a slight increase in the height of the module.

In order to suppress this change in the imaging point to a small value, it is good to make a part of or all the lenses formed out of a glass material (for example, glass molded lenses). When using glass molded lenses, in order to prevent as far as possible the wearing out of the forming molds, it is desirable to use a glassy material with a glass transition temperature (Tg) of 400° C. or less.

Further, recently, it has been found out that it is possible to suppress to a small value the temperature dependent changes in the refractive indices of plastic materials by adding inorganic fine particles within the plastic material. Explaining this in detailed terms, in general, when fine particles are mixed in a transparent plastic material, although it was difficult to use that material as an optical material because the transitivity decreased due to the occurrence of scattering of light, by making the size of the particles smaller than the wavelength of the transmitted light flux, it is possible to make the scattering effectively not to occur. Although the refractive index of a plastic material decreases as the temperature increases, the refractive index of the fine particles increases as the temperature increases. Therefore, by using these temperature dependencies so that they act to cancel each other, it is possible to make sure that there is almost no change in the refractive index. In concrete terms, when inorganic particles with a maximum size of 20 nanometers or less are dispersed in a base material of made of a plastic, it becomes a plastic material that has an extremely low temperature dependence of its refractive index. For example, when fine particles of niobium oxide (Nb₂O₅) are dispersed in acrylic, it is possible to make small the changes in its refractive index with changes in temperature. Even in the present invention, by forming a part or the whole of the image taking lens using such a plastic material in which fine inorganic particles have been dispersed, it is possible to suppress to a small value any variations in the position of the imaging point due to changes in the temperature of the entire imaging lens system.

Although in the above the first to the fifth preferred embodiments of the present invention have been described, the explanations of the case when the image taking apparatus 50 is installed in a mobile telephone unit 100 as a mobile terminal in the second to the fourth preferred embodiments are similar to those given in the case of the first preferred embodiment and are therefore omitted here.

In the above, although the present invention was described referring to some preferred embodiments, the present invention shall not be construed to be limited to the above preferred embodiments, but any suitable modifications and improvements thereto are of course possible to be made within the scope and intent of the present invention. For example, the movable lens can be any one or more lenses among the lenses L1 to L4, and also, the total number of lenses need not be restricted to four. In addition, in the above preferred embodiments, although the method of abutting and mating the flange sections has been used as the means for coupling a plurality of movable lenses, it is possible, for example, as has been disclosed in JP-A No. 2005-37865, to use a method in which the lenses 14a and 14b are dropped inside the lens body 12 and are fixed by the position fixing member 14d.

What is claimed is:

1. An image taking apparatus comprising:
a frame;
an image taking lens that includes at least one movable lens that can be moved in a direction of the optical axis of the image taking lens with respect to the frame;
a lens frame that supports the movable lens;
an actuator for moving the movable lens; and
a movable frame that is coupled to a movable element of said actuator;
wherein the lens frame and the movable frame are formed integrally.

2. The image taking apparatus according to claim 1,
wherein the actuator comprises a voice coil motor having a coil, a magnet, and a yoke, and said movable element is a coil or a magnet.

3. The image taking apparatus according to claim 1, further comprising:
a solid-state image sensor having a light receiving surface;
wherein the image taking lens includes a plurality of movable lenses and the actuator is a cylindrical shaped actuator that drives the plurality of movable lenses in a direction of the optical axis, and the most image side lens closest to the image side among the movable lenses has an external diameter larger than the internal diameter of the actuator, the movable lenses other than the most image side lens are placed on the inside of the internal diameter of the actuator along a direction perpendicular to the optical axis, and
wherein at least one part among the contacting parts between the most image side lens and the lens towards the object side from it is positioned, in a plane passing through the contacting part but perpendicular to the optical axis, more towards the inside in a direction perpendicular to the optical axis than the maximum value up to the outer edge of an effective light flux of said image taking lens entering the light receiving surface of the solid-state image sensor from the optical axis, and also is positioned more towards the outside in a direction perpendicular to the optical axis than the minimum value of the effective light flux of the image taking lens entering the light receiving surface of the solid-state image sensor from the optical axis.

4. The image taking apparatus according to claim 1,
wherein the actuator moves the movable lenses in the direction of the optical axis and the image taking lens includes a plurality of movable lenses, and
wherein at least two of the plurality of movable lenses are mutually coupled and at least a part of said actuator is placed on the outside of the coupled lenses in a direction perpendicular to the optical axis.

5. The image taking apparatus according to claim 4,
wherein the coupled lenses have their flange parts butting against and mating with each other.

6. The image taking apparatus according to claim 4, further comprising;
a light shielding sheet placed between the coupled lenses and the actuator.

7. The image taking apparatus according to claim 4,
wherein the actuator has a cylindrical shape and the most image side lens closest to the image side among the movable lenses has an external diameter larger than the internal diameter of the actuator, and
wherein at least two of the plurality of movable lenses other than said the most image side lens are placed on the inside of the internal diameter along a direction perpendicular to the optical axis.

8. The image taking apparatus according to claim 4,
wherein the actuator comprises a voice coil motor having a coil, a magnet, and a yoke.

9. The image taking apparatus according to claim 4,
wherein the plurality of movable lenses consists of four lenses, and at least a part of the actuator is placed on the outside of the three lenses excluding the lens closest to the image side in a direction perpendicular to the optical axis.

10. The image taking apparatus according to claim 1,
wherein the image taking lens includes a plurality of movable lenses and the actuator is a cylindrical shaped actuator that drives the plurality of movable lenses in a direction of the optical axis, and
wherein the most image side lens closest to the image side among the movable lenses has an external diameter larger than the internal diameter of the actuator, the movable lenses other than said the most image side lens are placed on the inside of the internal diameter of the actuator along a direction perpendicular to the optical axis.

11. An image taking apparatus according to claim 10,
wherein the actuator comprises a voice coil motor having a coil, a magnet, and a yoke.

12. The image taking apparatus according to claim 10,
wherein the plurality of movable lenses consists of four lenses.

13. An image taking apparatus according to claim 1, further comprising:
a solid-state image sensor;
a substrate which holds the solid-state image sensor and includes a terminal for the external connection for sending and receiving electric signal; and
a casing formed of a light shielding member fixed to the substrate in such a manner to surround the periphery of the solid-state image sensor and the image taking lens;
wherein when the size of the image taking apparatus in the direction of the long side of the image sensor rectangular effective pixel area is taken as X, and the size of image taking apparatus in the direction of the short side of the image sensor rectangular effective pixel area is taken as Y, and the length of the diagonal line of the rectangular effective pixel area of the solid-state image sensor is taken as DL, the image taking apparatus satisfies the conditions of
1.5<X/DL<2.0 (1)
2.5<Y/DL<2.0 (2),
and wherein the image taking lens includes a plurality of lenses where the most image side lens of the plurality of lenses has an effective diameter larger than the effective diameters of the other lenses of the plurality of lenses, and
wherein the actuator, at least a part of which is arranged in a space generated in the minimum effective diameter lens periphery by the difference of the outer diameter of the minimum effective diameter lens in the plurality of lenses and the outer diameter of the maximum effective diameter lens in the plurality of lenses, is arranged for driving a focusing lens group of the image taking lens which is driven at a time of focusing and the maximum value of the drive current of the actuator is 50 mA or more but no more than 200 mA.

14. The image taking apparatus according to claim 13,
wherein the maximum value of the drive current of the actuator is 50 mA or more but no more than 100 mA.

15. The image taking apparatus according to claim 13,
wherein the actuator comprises a voice coil motor.
